(19) United States
(12) Patent Application Publication
(10) Pub. No.: US 2016/0359207 A1
(43) Pub. Date: Dec. 8, 2016

(54) THERMALLY-PROTECTED CHEMICAL-CELL BATTERY SYSTEM

(71) Applicant: ABOMINABLE LABS, LLC, Lake Oswego, OR (US)

(72) Inventors: JACK C. CORNELIUS, LAKE OSWEGO, OR (US); VINCENT O'MALLEY, PORTLAND, OR (US)

(73) Assignee: ABOMINABLE LABS, LLC, Lake Oswego, OR (US)

(21) Appl. No.: 14/733,747

(22) Filed: Jun. 8, 2015

(51) Int. Cl. H01M 10/615; H01M 10/623; H01M 10/657; H02J 7/00; H01M 10/42; H01M 10/44; H01M 10/46; H01M 10/48; H01M 10/0525; H01M 10/658

(52) U.S. Cl. CPC H01M 10/615; H01M 10/0525; H01M 10/623; H01M 10/657; H01M 10/658; H01M 10/4257; H01M 10/443; H01M 10/46; H01M 10/486; H02J 7/007; H02J 7/0052; H01M 2010/4271; H01M 2010/4278; H01M 2220/30

(57) ABSTRACT

Thermally-protected heatable chemical cell battery system adapted for providing power to an electronic device comprising a chemical cell battery, control circuitry operatively connected with the battery, a heating element operatively connected with the control circuitry and the battery, the heating element being powered by the battery and located adjacent the battery, the control circuitry providing sufficient power from the battery to the heating element, optionally responsive to a temperature sensor and temperature feedback system, to improve the operating performance of the battery and to control charging, a preferably Aerogel insulating member surrounding the battery and the heating element, contact leads passing through a portion of the insulating member and an optional protective cover adapted for conveying power from the battery to the electronic device.

### FIELD

This patent application relates generally to chemical cell batteries and more particularly to a thermally-protected chemical-cell battery system for controlling temperature of a chemical cell battery so as to improve its performance in otherwise cold-temperature environments.

### BACKGROUND

Use of hand-held electronic devices, and other portable battery-powered electronic devices, such as cell phones, Global Positioning System (GPS) devices, tablet computers, laptop computers, athletic equipment such as goggles, heated clothing, and the like, in outdoor environments where temperatures range greatly, has greatly increased in recent years. Users of such devices have included people involved in athletic and recreational pursuits, rescue operations, scientific field operations, military operations and others. As a result, it is a known phenomenon that cold-weather temperatures, as well as excessive heat, has an adverse effect on the operation and charging of certain battery systems.

### Affect of Temperature on Battery Operation

The operation of chemical cell batteries converts stored chemical energy into electrical energy. Each cell of a chemical cell battery contains a positive terminal, known as a cathode, and a negative terminal, known as an anode. An electrolyte solvent solution allows positively-charged ions to move between the electrodes and terminals, which enables electrical current to flow out of the battery.

Ion conductivity within the electrolyte solvent solution greatly affects the amp-hour performance and recharging and recycling performance of chemical cell batteries, such as for example lithium-ion batteries, lithium poly batteries, or any other chemical cell battery the operation of which is dependent upon temperature. Thus, for example, in a Li-ion battery, a solvent is used to dissolve the Li-ion salt, and the viscosity of the solvent, which is greatly affected by temperature, in turn affects the rate at which the ions transport through the solvent.

Ion conductivity depends upon the viscosity of the solvent and the dielectric constant of the solvent. The viscosity of the solvent affects the mobility of ions, as shown in the equation:

$$mobility = \frac{1}{6 πη {r}_{i}}$$

where rᵢ is the radius of solvated ions.

Different mixtures of solvents will have different viscosity properties at different temperatures. Further, a small difference in viscosity can significantly affect ion mobility. Accordingly, for chemical cell batteries to perform consistently and optimally, there is a need to regulate the temperature at which the battery operates, regardless of external temperatures.

The amp-hours capacity and charge cycle performance of chemical cell batteries is known to be diminished during use at too low of operating temperatures as well as during use at too high of operating temperatures. This is in part because low temperature operation results in high electrolyte viscosity and poor ion conductivity properties, and also because at extreme temperatures, electrolyte component phase separation can occur, which in turn affects ion transport properties.

FIG. 1 is adapted from a graph illustrating lithium-ion chemical cell battery discharge capacity versus recharge cycles and temperature, wherein discharge capacity is a function of cycles and temperature. The cells tested were cycled at 1 Amp between 0% and 100% (representing “Full” use) state-of-charge at 0° C. (32° F.), 20° C. (68° F.) and 40° C. (104° F.). As shown, batteries that would provide 1.5 amp-hours capacity and 600 recharging cycles at 20° C. (68° F.) will typically ultimately deliver only 0.75 amp-hours and 300 recharging cycles capacity at 0° C. (32° F.). See Characteristics and Behavior of Cycled Aged Lithium Ion Cells, Laura M. Cristo and Terrill B. Atwater, US Army Communications, Electronics, Research, Development and Engineering Center (RDECOM), Ft. Monmouth N.J. www.dtic.mil/cgi-bin/GetTRDoc?AD=ADA527711 (2010).

Thus, generally, the cells cycled at cold temperature show continual decrease in capacity while being cycled at temperature. The level of performance decline associated with extreme temperature operation depends on the battery chemistry and the amount of time the battery is subjected to extreme temperatures. Also, battery capacity decrease is linear with temperature decrease/increase, and battery capacity decrease is momentary in that, while battery amp-hour performance at excessively cold or hot temperatures starts out normal, over a time of repeated cycling at extreme temperatures, battery amp-hour and charge cycle performance quickly degrades as shown.

Further, as shown after failure of a battery to recharge after 300 recharge cycles at cold temperature operation, say at 0° C. (32° F.), resumed warmer temperatures for the battery, say at 20° C. (68° F.), will revive the battery for additional cycles of operation. Nevertheless, overall battery re-charging cycle capacity is compromised as compared with consistent cycling of the battery at optimum operating temperatures. At minus (−20°) C. (−4° F.) most nickel-, lead- and lithium-based rechargeable batteries stop functioning. Further, such batteries cannot be charged if the battery is at a temperature below 0° C. or higher than 60° C.

Accordingly, chemical cell batteries perform better at moderate temperatures than at excessively low or excessively high temperatures. And while warmer temperatures, as compared to colder temperatures, lower the internal resistance of chemical cell batteries, operation of the batteries at excessive heat will stress the batteries and negatively impact their amp-hours and cycling performance. Further, over-discharge at a heavy load and at low temperatures contributes to battery failure.

Responsive to these limitations, there have been provided specially built batteries, such as for example lithium iron phosphate (LiFePO₄), or lithium/iron disulfide (Li/FeS₂), that are able to function down to −40° C., but typically at reduced discharge levels.

### Electronic Control of Batteries and Heating Elements

Certain chemical cell battery packs, such as for example Li-ion packs, include protection circuits to regulate battery discharge to prevent rapid discharge. While the protection circuits help prevent battery failures resulting from rapid discharge, such protection circuits do not improve the performance of batteries operating at temperature extremes outside optimal battery operating temperatures.

U.S. Pat. No. 8,566,962 to Cornelius for PWM Heating System for Eye Shield teaches the use of pulse-width modulated circuitry for ensuring even heating, or alternatively custom heating, of eye shields using battery power. U.S. patent application Ser. No. 14/046,969 to O'Malley et al. for Battery Compensation System Using PWM teaches a system for regulating battery output to ensure level battery power over a discharge cycle, or life, of the battery. U.S. patent application Ser. No. 14/556,128 to Cornelius et al. for Micro-Current Sensing Auto-Adjusting Heater System for Eye-Shield teaches a system for regulating battery output to ensure consistent heating on eye shields despite resistance variations of heating elements from one region of an eye-shield to another region, or from one eye-shield to another. However, none of the foregoing patent or patent applications teach the use of control circuitry for using battery power to heat the battery itself to maintain the battery at an optimal operating temperature despite external environment temperature.

### Insulating Material

Various materials are available which are known for their thermal insulating properties. One particularly effective insulating material is known in the industry as Aerogel, a synthetic porous ultralight material derived from a gel in which the liquid component of the gel has been evaporated and replaced with a gas. Aerogels are 98.2% gas and have a dendritic microstructure, accounting for the fact that they are extremely lightweight, have good load bearing abilities, are very poor conductors of heat and electricity, and are very good convective inhibitors. Examples of Aerogels are microporous silica, microporous glass and zeolites.

### Conclusion

Various devices utilizing battery power, such as cell phones, mobile computing devices, GPS devices, heated eye-shields, etc., exhibit reduced discharge and cycling capacity, resulting in diminished enjoyment and use of the device during use in extreme temperature situations outside of optimal operating temperature ranges. This reduced performance, in turn, has led to decreased enjoyment, injury, death, and unsuitability for use during cold-, or high-, temperature operations.

Further, the frequent need for use of battery-operated devices in cold-temperature environments has led to decreased battery life in terms of reduced recharging cycles of such devices and their batteries, and has made it more difficult for manufacturers of such devices, and their batteries, to ensure for their customers optimum battery performance in their products.

### SUMMARY OF THE INVENTION

In accordance with an aspect of the invention, there is provided a thermally-protected chemical cell battery system, otherwise known as a thermally-protected battery unit, pack or system, heated or adapted for being heated, and providing power to an electronic device comprising: a chemical cell battery, a heating element operatively connected with the battery, the heating element being powered by the battery and located adjacent the battery, an insulating member at least partially surrounding the battery and the heating element, and contact leads passing through the insulating member adapted for conveying power from the battery to the electronic device. Power to the heating element is supplied from the battery, and the heating element and the battery are preferably contained within the insulating member for enabling sufficient warmth to the battery using a minimum of battery power, thus conserving battery life, and to improve the battery's operating performance characteristics which would otherwise be compromised by cold temperatures. The thermally-protected chemical cell battery of this aspect of the invention may optionally be adapted for being housed within the device, such as a cell phone, a GPS device, a goggle, or other electronic device for use by outdoor enthusiasts, outdoor recreationalists, athletes, military personnel, emergency responders and rescuers, to which the thermally-protected heated chemical-cell battery is to supply battery power. Further, the thermally-protected battery of this aspect of the invention may optionally be controlled via control circuitry which is incorporated as part of the electronic device to be powered by the battery.

In accordance with another aspect of the invention, there is provided a thermally-protected heatable chemical cell battery system adapted for providing power to an electronic device comprising: a chemical cell battery, control circuitry operatively connected with the battery, a heating element operatively connected with the control circuitry and the battery, the heating element being powered by the battery and located adjacent the battery, an insulating member at least partially surrounding the battery, the control circuitry and the heating element, and contact leads passing through a portion of the insulating member adapted for conveying power from the battery to the electronic device. Power to the heating element is supplied from the battery preferably via the control circuitry preferably contained on a circuit board and preferably contained within the insulating member for enabling sufficient warmth to the battery using a minimum of battery power, thus conserving battery life, and to improve the battery's operating performance characteristics which would otherwise be compromised by cold temperatures. Preferably, at least the heating element and the battery, and optionally the control circuitry, may be fully contained within an insulating member enclosure for enabling warmth to the battery using less battery power over a single use cycle than would otherwise be lost as a result of operating the battery at cold temperatures. The power from the battery passes through the contact leads passing through and to the outside of the insulating member, as through sealing grommets, to enable connection to the electronic device to which the battery is connected for powering the electronic device.

The thermally-protected heated chemical cell battery system of this aspect of the invention may optionally be adapted for being housed within the device itself, such as a cell phone, a GPS device, a goggle, or other electronic device for use by outdoor enthusiasts, outdoor recreationalists, athletes, military personnel, emergency responders and rescuers, to which it is to supply battery power. Further, the control circuitry of the thermally-protected battery system of this aspect of the invention may optionally be incorporated as part of the electronic device to be powered by the battery.

In accordance with another aspect of the invention, there is provided the thermally-protected heatable chemical cell battery system adapted for providing power to an electronic device of the previously-described aspects of the invention, further comprising: a protective cover surrounding the insulating member. The protective cover of this aspect of the invention is primarily for housing the battery, the heating element, the control circuitry and the insulating member, thus preventing them from damage or disassembly. Further, the contact leads also pass through a portion of the protective cover, as through sealing grommets, to enable interconnection of the battery within the protective cover, and within the insulation member/barrier, to the electronic device for which the battery is intended for power.

These aspects of the invention address the limitations of prior art battery systems which have allowed battery temperature to drop below optimum battery operating temperature to thus negatively impact battery amp-hours and cycling performance. The amount of power used to warm the battery is minimized and is a function of the efficiency of the heating element and insulating member or structure used to warm and retain heat around the battery. Preferably a highly efficient insulation member is used, such as an Aerogel microporous silica, microporous glass, or zeolite insulating container, in which case the power required to warm the battery is less than the power loss associated otherwise with cold-temperature operation of the battery. This in turn represents a net increase in amp-hours of battery performance, and also improved battery re-charge cycle performance, than is otherwise the case given excess cold-temperature of the battery during operation.

In accordance with another aspect of the invention, the thermally-protected chemical cell battery system of any of the other aforementioned embodiments or aspects of the invention further comprises a switch for switching on or off the heating element for heating the battery to accommodate for various temperature operation situations. Thus, in the case of cold-temperature operating environments where battery longevity is a concern, the user may operate the switch to select a heated battery operation mode to maintain the optimum amp-hours of battery performance and the optimum degree of battery cycle longevity, despite otherwise cold-temperature operating environments.

In accordance with another aspect of the invention, the thermally-protected chemical cell battery system of any of the other aforementioned embodiments or aspects of the invention is provided with a temperature sensor located on or adjacent the battery and within the insulating member, and temperature feedback circuitry operatively connected to the control circuitry, to enable determination and reporting back through the feedback circuitry of the battery operating temperature to enable automatic electronic adjustment by the control circuit of the amount of battery power diverted to heating the battery heating element. Thus, the temperature sensor enables the control circuitry to automatically adjust power to the heating element upon receipt of a temperature input from the temperature sensor.

This aspect of the invention provides more flexibility and automation in applying heat to the battery heater structure to prevent overheating of the chemical cell battery and to allow battery temperature to remain at an optimum temperature for a given type of battery, despite ambient temperature, and without the need for manual intervention by a user to operate a switch to turn on the battery heater. Further, this aspect of the invention allows automatic conservation of battery power diverted to heating of the battery.

In accordance with another aspect of the invention, a temperature-sensor-enabled embodiment of any of the other aforementioned embodiments or aspects of the invention may be further provided with temperature-controlled battery charging circuitry where the microcontroller monitors battery temperature and does not allow the battery charging circuitry to operate to charge the battery if the battery is below a minimum charging temperature threshold, for example 0° C., or if the battery is above a maximum charging temperature threshold, for example 45° C.

Thus, in accordance with this aspect of the invention, there is provided a thermally-protected chemical cell battery of any of the previously-described temperature sensor embodiments of the invention, further comprising a controlled charging system enabling charging of the battery upon verification that the temperature of the battery is within a pre-determined range. The controlled charging system of this aspect of the invention automatically signals heating of the battery by the heater in the event the battery is verified to be at a temperature below the pre-determined temperature range. Upon increasing the temperature of the battery to within the pre-determined range, the microcontroller automatically signals commencement of charging of the battery by the charging system.

If, in accordance with this aspect of the invention, the user attempts to charge the battery when the temperature is below the minimum charging temperature threshold, the microcontroller enables the battery pack heating element using an external power feed, either AC or DC, to raise the temperature above the threshold. Once the battery temperature is above the minimum charging threshold, the microcontroller enables the battery charging circuitry and charging begins.

This aspect of the invention enables automated charging of the battery even if ambient temperatures are very cold, thus enabling charging of a battery pack which would not otherwise be possible without some other means of heating the battery. This, in turn, represents a convenience to the user not heretofore provided.

In accordance with another aspect of the invention, there is provided a thermally-protected chemical cell battery system of any of the aforementioned aspects of the invention, further comprising a second chemical cell battery operatively connected with the control circuitry, wherein the insulating member, for example an Aerogel insulating member, at least partially surrounds the battery (i.e., the battery first mentioned above), the second battery, the control circuitry and the heating element. Further, in the case where a metal protective cover is employed, the metal protective cover would further at least partially surround, but preferably would substantially completely surround, the first battery, the second battery, the control circuitry, the heating element and the insulating member. Preferably in accordance with this aspect of the invention, the heating element is positioned between the first chemical cell battery and the second chemical cell battery to enable efficient heating of both batteries with a single heating element.

This aspect of the invention enables the user to have more battery power in a single heated chemical cell battery system by providing for two batteries within a single battery pack. This in turn allows longer battery activation times for the device to be powered by the battery system. This aspect of the invention may also be used to allow different batteries within the battery pack for different purposes, for example one to power the electronic device and one to heat the battery pack.

In accordance with yet another aspect and embodiment of the invention, there is provided a heated chemical cell battery system of any of the aforementioned aspects of the invention, further comprising another battery (i.e., a backup battery) that is specially formulated for operation in cold weather and operatively connected with a heating element. The other battery in accordance with this aspect of the invention comprises a lithium iron phosphate (LiFePo₄), or a lithium/iron disulfide battery (Li/FeS₂—e.g., an L91 battery) able to function down to −40° C. This other battery may optionally be located and retained outside of the insulating member, since it is able to operate at colder temperatures, and may be used to power the heater to warm the first battery housed within the insulating member. In this aspect of the invention, the insulating member, for example an Aerogel insulating member, at least partially surrounds the first battery (i.e., the battery first mentioned above), and the heating element. In the case where a metal protective cover is employed with this aspect and embodiment of the invention, the metal protective cover would further at least partially surround, but preferably would substantially completely surround, the first battery, the heating element and the insulating member. The second battery could also be contained within, or outside, of the protective cover, but preferably within to protect it from damage. In accordance with this aspect of the invention, the other, backup, battery need not be retained within the insulating member.

In accordance with this aspect of the invention, if the temperature of the first, or primary, battery falls below the recommended operating temperature of the first battery, the other, backup, battery may be used to warm the first battery up to a minimum threshold temperature before attempting use or charging of the first battery. The other, backup, battery may be activated with the use of an on/off switch, or it may be controlled with a temperature sensor and control circuitry. Once the first battery achieves sufficient warmth for operation on its own, power for maintaining the first battery within an appropriate operating temperature may be supplied either from the first battery or the backup battery.

This aspect of the invention enables the user to have more flexibility in how the primary battery may be warmed to enable efficient operation and charging, since the external battery, e.g., an L91 battery, may be housed outside of the primary battery pack surrounded by the insulating member and optionally the protective cover. This, in turn allows for differing packaging approaches to this aspect of the invention.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1 is a graphic illustration showing the relationship between battery performance, cycling and operating temperature of the battery;

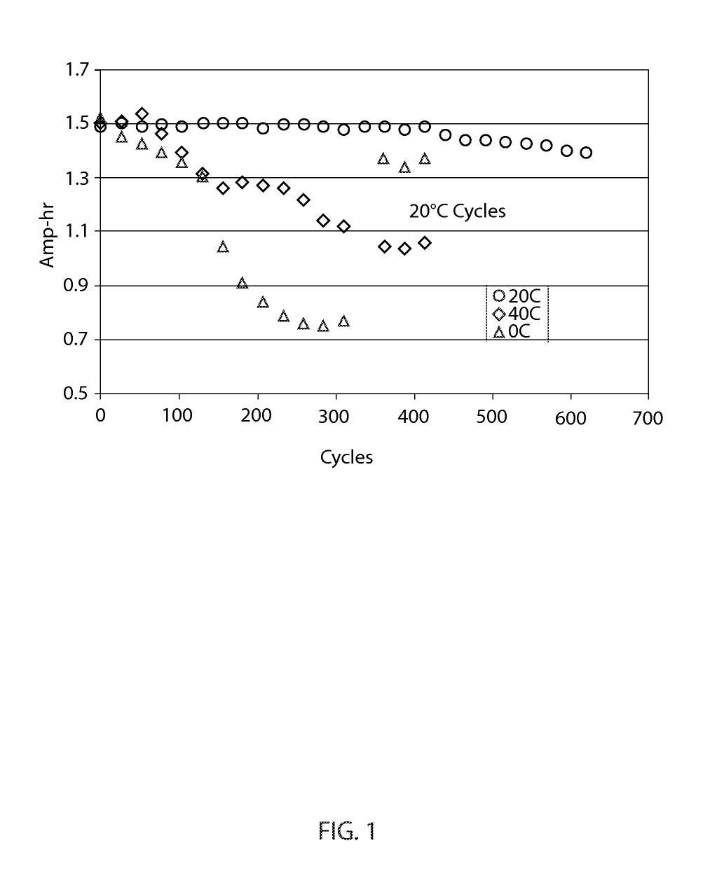

FIG. 2 is a sectional front view of an embodiment of a heated chemical cell battery system in accordance with an aspect of the invention;

FIG. 3 is a sectional front view of another embodiment of a heated chemical cell battery system in accordance with an aspect of the invention;

FIG. 4a is a sectional back view of another embodiment of a heated chemical cell battery system contained within a hand-held computing device, such as a commonly available data, or smart, phone, and in accordance with an aspect of the invention;

FIG. 4b is a sectional back view of another embodiment of a heated chemical cell battery system contained within a hand-held GPS device and in accordance with an aspect of the invention;

FIG. 4c is a partial sectional back view of another embodiment of a heated chemical cell battery system contained within a tablet computing device and in accordance with an aspect of the invention;

FIG. 4d is a sectional front view of another embodiment of a heated chemical cell battery system contained within a heated goggle and in accordance with an aspect of the invention;

FIG. 5 is a sectional front view of another embodiment of a heated chemical cell battery system in accordance with an aspect of the invention;

FIG. 6 is a perspective view of an embodiment of a heated chemical cell battery system in accordance with an aspect of the invention;

FIG. 7 is a basic heating system circuit diagram for control circuitry in accordance with an embodiment of the invention;

FIG. 8 is an alternate circuit diagram for control circuitry in accordance with another embodiment of the invention comprising use of a temperature sensor;

FIG. 9 is a sectional front view of an alternate embodiment of a heated chemical cell battery system in accordance with an aspect of the invention;

FIG. 10 is a sectional front view of an alternate embodiment of a heated chemical cell battery system in accordance with an aspect of the invention; and

FIG. 11 is an illustration of a military user of the invention in a battery pack worn on a tool belt for use in operating a corded hand-held electronic device.

### DETAILED DESCRIPTION

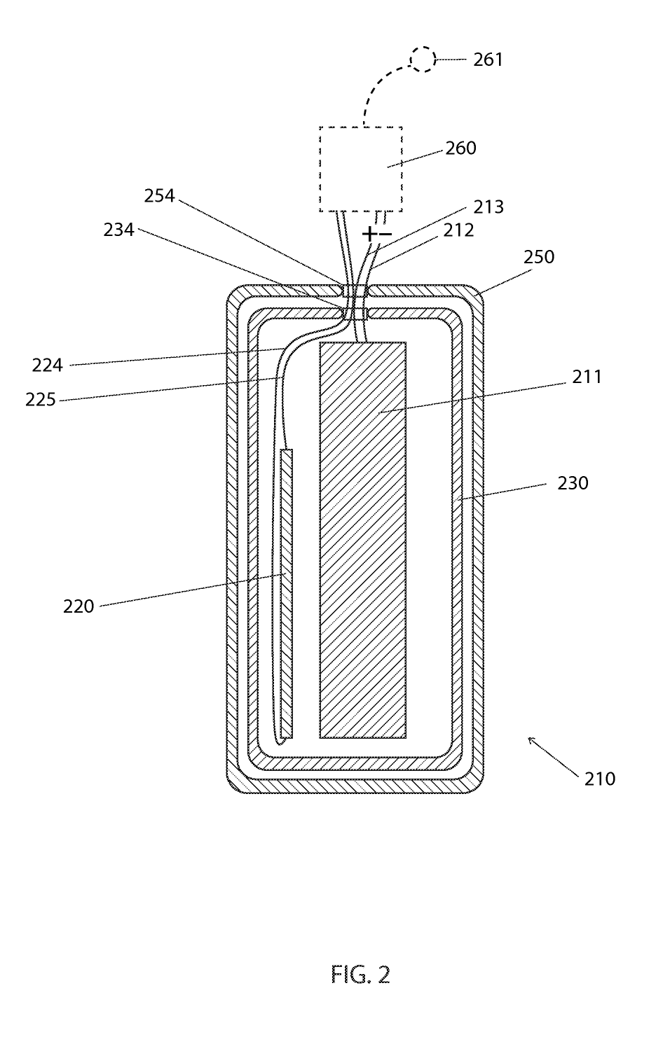

Referring now to FIGS. 2-6, various embodiments of the invention are shown comprising a thermally-protected heatable chemical cell battery system for use in supplying power to an electronic device such as: a cell phone, a handheld GPS unit, a tablet, a computing device, a heated goggle, a heated visor, etc.

Referring specifically to FIG. 2, there is shown a thermally-protected chemical cell battery system 210 in accordance with an embodiment of the invention. The thermally-protected chemical cell battery system 210 comprises a chemical cell battery 211, such as a rechargeable lithium-ion battery, a lithium-poly battery, or other chemical cell battery such as would be adversely affected by extreme temperature operating conditions. Preferably, the thermally-protected chemical cell battery system 210 further comprises a heating element 220 which may be comprised of a metal core covered with a thin film heating material, such as an indium tin oxide coating, or a silver nano-wire coating. The heating element 220 is optionally connected to and controlled by a processor 260 via leads, or wires, 224, 225, and the system may also be benefited as described further below by an external, ambient, temperature sensor 261. The battery 211 and heating element 220 of this embodiment and aspect of the invention are enclosed, at least partially, but preferably virtually entirely, by an insulating member 230. Preferably the insulating member is comprised of Aerogel, a material known for excellent thermal insulating properties. Aerogel is a synthetic porous ultralight material derived from a gel in which the liquid component of the gel has been evaporated and replaced with a gas. It is 98.2% gas and has a dendritic microstructure, making it extremely lightweight. Commonly available Aerogels include microporous silica, microporous glass, and zeolites.

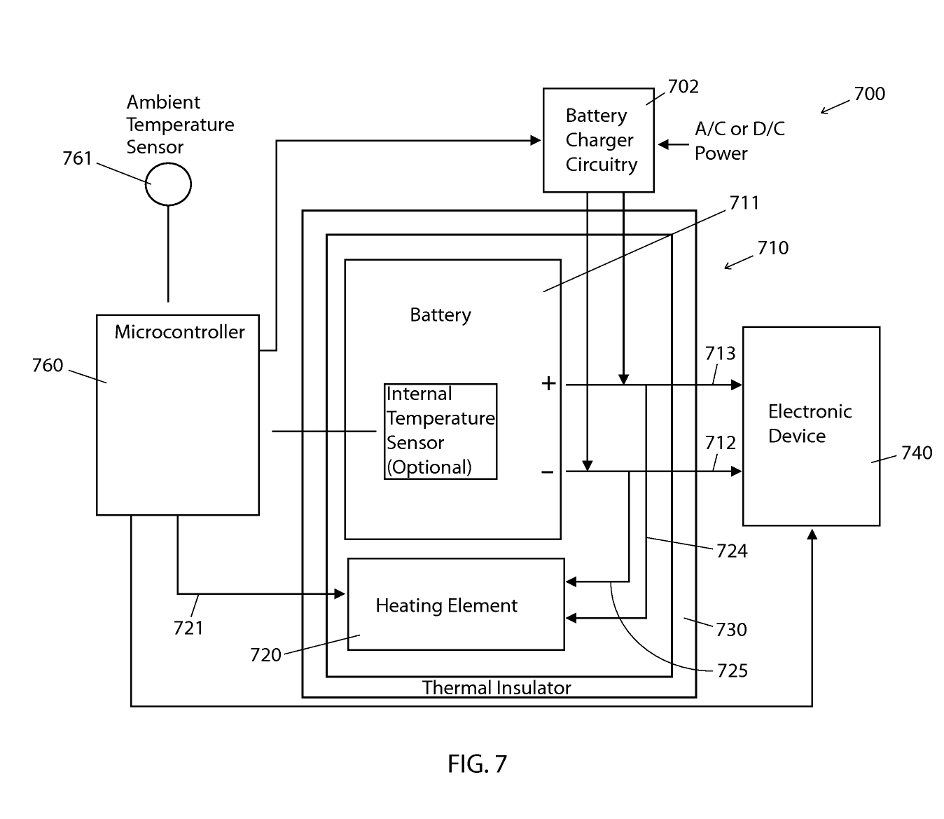

The insulating member 230, as shown in FIG. 2, creates at least a partial, but preferably a more complete, insulating barrier surrounding or containing the battery 211, the heating element 220, and at least part of the lead wires 212, 213, 224, 225. There is a preferably sealed opening, as for example with a grommet 234, in the insulating member so that the lead wires 212, 213, 224, 225 may pass through the insulating member without leaking too much of the heat to be retained within the insulating member. Lead wires 212, 213 comprise negative and positive leads, respectively, from the battery to an external (in this embodiment) processing unit 260. The lead wires 224, 225 provide operative control between the heating element, or member, 220 and the external processing unit 260. The processing unit 260 controls the amount of power from the battery 211 supplied to the heating element 220 as described below in connection with a basic heating system diagram shown in FIG. 7.

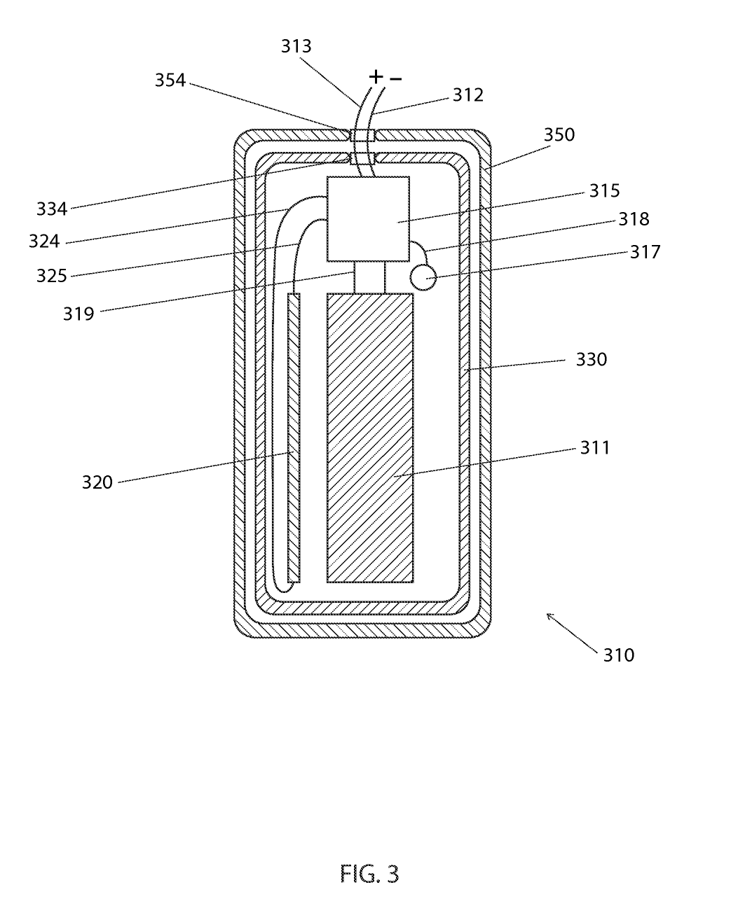

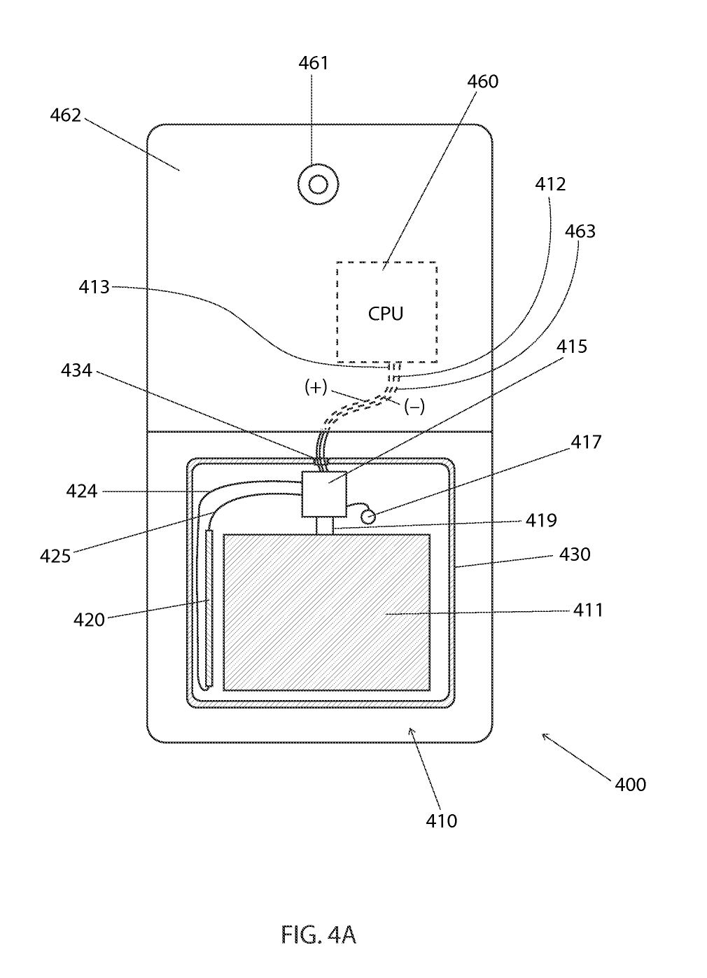

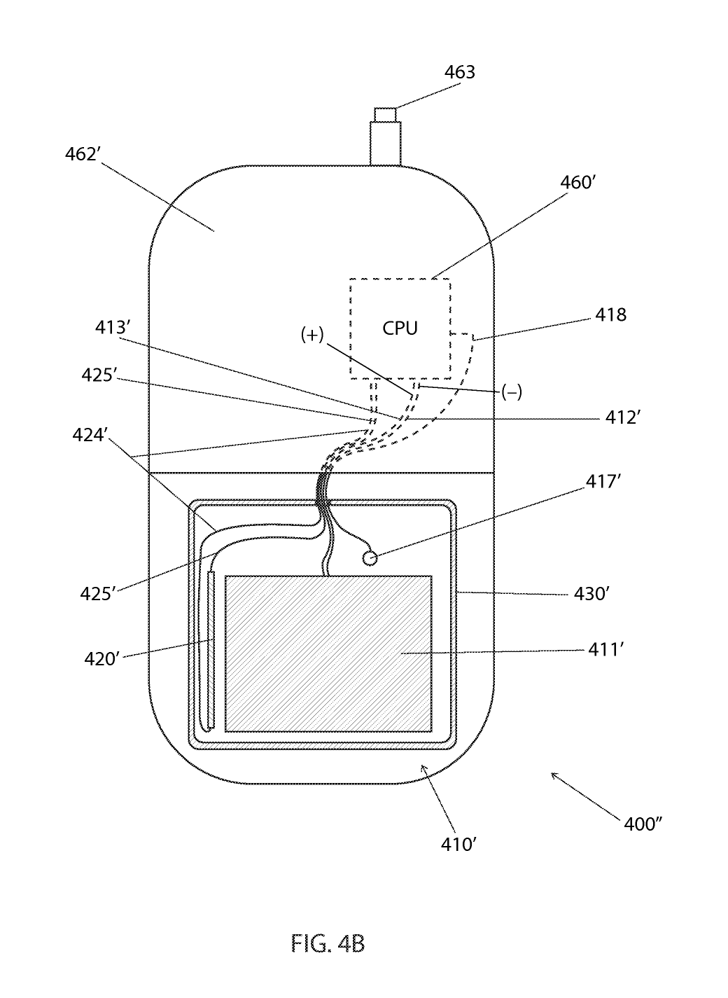

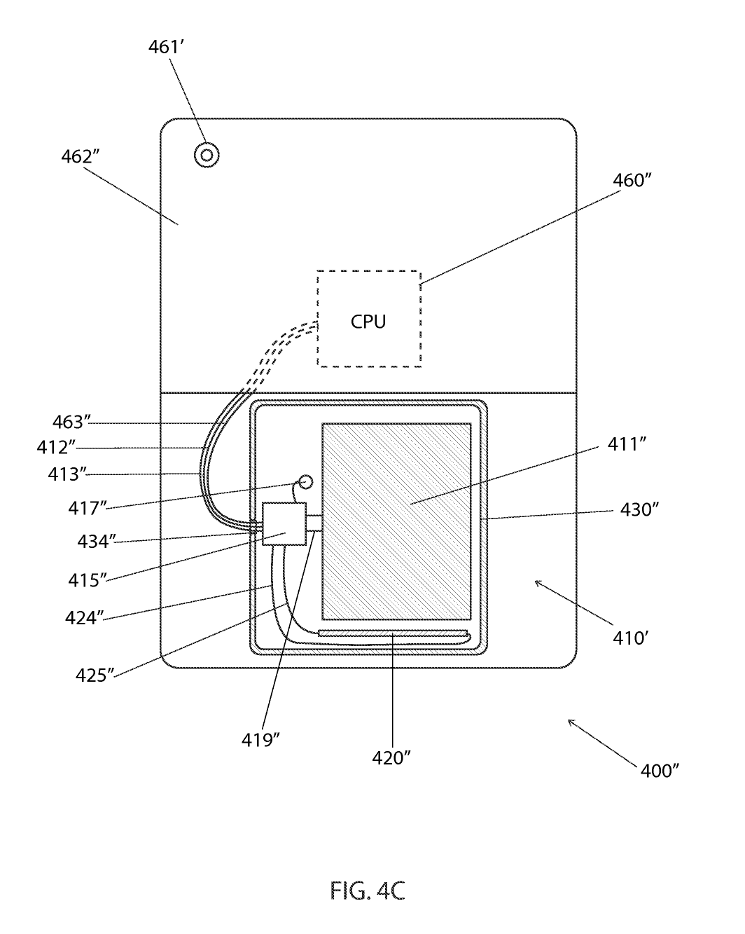

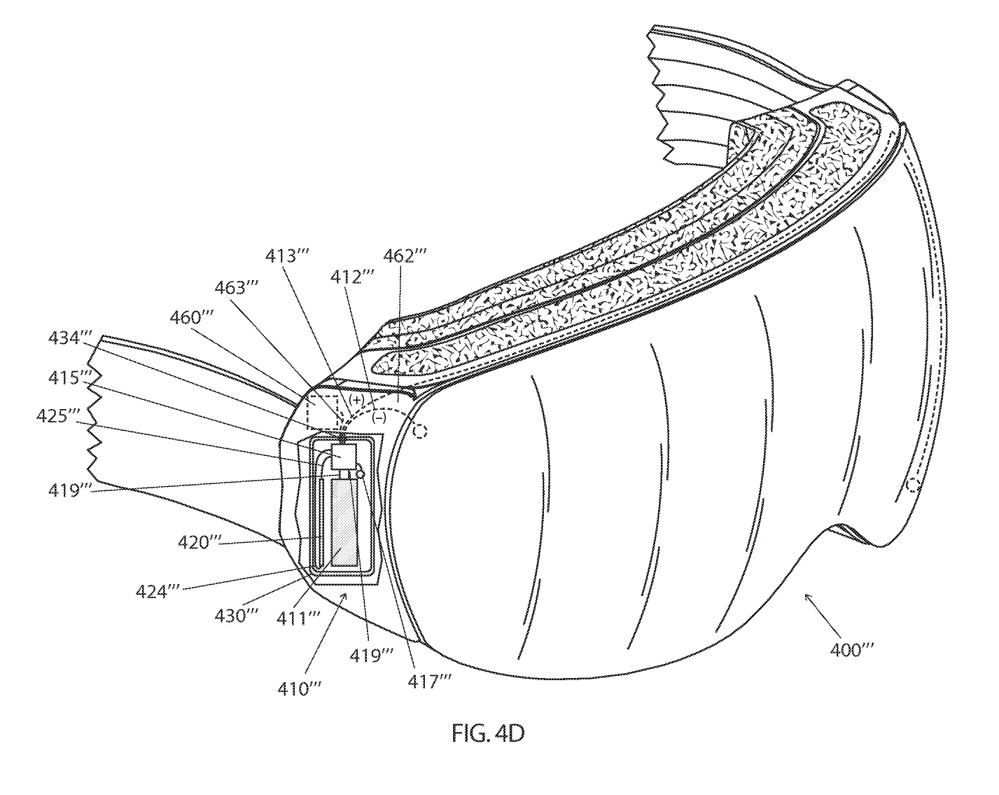

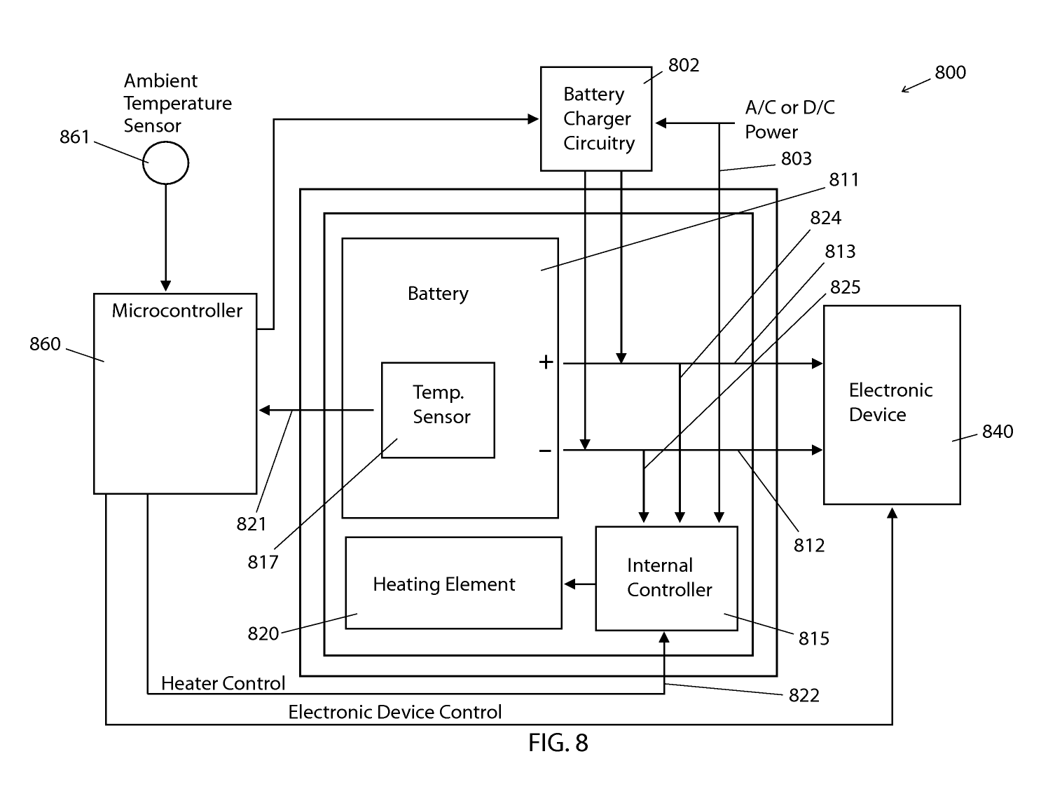

Referring to FIG. 7, an example basic thermal protection heating system circuit diagram is shown. The circuit 700 comprises an external microcontroller 760 (e.g., microcontroller 260 of FIG. 2, or one of the CPU's 460, 460′, 460″, 460′″ of FIGS. 4a, 4b, 4c, 4d, respectively) which sends heating control signals at 721 to control a heating element 720 (e.g., heating element 220 of FIG. 2) within an approximated pre-determined temperature range based upon ambient temperature data received from an external, ambient, temperature sensor 761 (e.g., external temperature sensor 261 of FIG. 2). The external, ambient, temperature sensor 761 may be part of the electronics device 740 (i.e., device 400, 400′, 400″, 400′″ of FIGS. 4a, 4b, 4c, 4d) of the system to be powered. The microcontroller 760 controls battery power from the battery 711 to the electronic device via circuit wires 712 (−) and 713 (+). The battery is charged via charger circuitry 702 which is also controlled by the microcontroller 760. Alternatively, as shown in FIG. 3, some of the heating system control electronics may optionally be housed within the battery system as further described below in connection with FIG. 8.

Thus, based upon ambient temperature data received from the external temperature sensor 761, the microcontroller 760 operates a program for activating the heating element 720 to heat the battery 711 via circuit wires 724, 725 within a thermal insulator 730 when ambient temperature falls to below a pre-determined temperature, such as for example −10° C. The microcontroller 760 turns the heating element 720 off after a pre-determined time of operation, for example 15 minutes, depending upon the magnitude and amount of heat to be supplied per design.

With the basic thermal protection and heating system 700 of FIG. 7, the variables of heating magnitude and heating time are pre-programmed so as to ensure that the battery 711 operates in an approximate, generally optimal, temperature range. Thus, if a lower heat is to be supplied by heating element 720, the pre-determined time of operation may be programmed to be longer, whereas if a higher heat is to be supplied, the pre-determined heating time may be shorter. Thus, when designing the basic system 700 and program, it should be considered that different battery technologies have different operating temperature limitations. For example, with a Lithium Ion rechargeable battery system, the battery should not be discharged if at a temperature below −20° C. or higher than 60° C. Further, as shown and described previously, such battery systems operate more optimally within certain temperature ranges, for example at around 20° C. Accordingly, the size and volume of the space to be heated, the efficiency of the insulating member 730, together with the resistivity of the heater 720, and quantity of power from the battery 711, must be selected so as to not risk operation outside of these limits and undue discharge of the battery for heating purposes.

Surrounding, or otherwise containing, the battery 211, the insulating member 230, the heating element 220, and at least part of the lead wires 212, 213, 224, 225, is a protective cover, or case, 250. Preferably, the protective cover 250 is comprised of a metal or plastic material that is rigid, durable and hard so as to house and protect the battery 211, the heating element 220, and especially the Aerogel insulating member 230 from damage or disassembly.

The thermally-protected heatable chemical cell battery system 210 of FIG. 2 may optionally be adapted for being housed within an electronic device itself, such as a cell phone 400, a GPS device 400′, a tablet computer 400″, a goggle system 400′″, or other electronic device, as for example shown in FIGS. 4a-4d, and to which the thermally-protected battery system 210 is to supply battery power. Further, the control circuitry 260 of the thermally-protected chemical cell battery system 210 of this aspect of the invention may optionally be incorporated as part of the electronic device to be powered by the battery 211.

Referring now to FIG. 3, there is shown an alternate embodiment of a thermally-protected heatable chemical cell battery system 310 in accordance with another aspect of the invention. The thermally-protected chemical cell battery system 310 of this embodiment of the invention, similarly to the thermally-protected chemical battery system 210, comprises a chemical cell battery 311, such as a rechargeable lithium-ion, lithium-poly, or other chemical cell battery, that is susceptible to reduced performance during operation in excess temperature environments, and a heating element 320. In this embodiment of this aspect of the invention, there is an internal processor 315, preferably contained on a circuit board 315. The chemical cell battery 311 is operatively interconnected to the internal processor 315, and the processor 315 also is operatively interconnected to heating element 320. The interconnection between the battery 311 and the processor 315 is comprised of lead wires 319. Further, there are lead wires 324, 325 which operatively interconnect the heating element 320 and the processing unit 315. As shown and described in connection with FIG. 8 below, control of the heater may be further accomplished with an external microcontroller or CPU from the device to be powered.

Similarly to the thermally-protected chemical cell battery system 210 described in connection with FIG. 2, the thermally-protected chemical cell battery system 310 of FIG. 3 further comprises an insulating member 330 comprised preferably of Aerogel or other suitable insulating material. Preferably, the insulating member 330 surrounds, or otherwise contains, the battery 311, the heating element 330, the processing unit 315, lead wires 319, 324 and 325, and a temperature sensor 317 operatively interconnected with the processing unit 315.

Thus, the thermally-protected chemical cell battery system 310, as well as any of the other embodiments described herein, may be provided with a temperature sensor 317 located adjacent the battery 311 and within the insulating member 330 for sensing the internal temperature of the thermally-protected heated battery system 310. Temperature feedback circuitry, represented in part at 318, is operatively connected to the control circuitry within processing unit 315. The temperature sensor 317, temperature feedback circuitry 318, and control circuitry 315 enable determination, communication and processing of the battery operating temperature, as affected by the heating element 320 and the ambient temperature within the insulating member 330, to enable feedback to the processing unit 315 and automatic electronic adjustment by the control circuitry of the processing unit 315 of the amount of battery power to be diverted to heating the battery heating element 320 as described below in connection with FIG. 8. Thus, the temperature sensor 317 enables the control circuitry to automatically adjust power to the heating element 320 within a desired temperature range upon receipt of a temperature input from the temperature sensor.

Use of temperature feedback circuitry 318 provides more flexibility and automation in applying heat to the battery heating element 320 to prevent overheating of the chemical cell battery 311 and to allow battery temperature to remain at an optimum temperature for a given type of battery, despite ambient temperature outside of the system or electronic device in which the system is incorporated, and without the need for manual intervention by a user to operate a switch to turn on the heating element 320. Further, this allows automatic conservation of battery power diverted to heating of the battery 311. In this way, the heating element 320 may be automatically turned on if additional power is indicated by the processing unit 315, if additional warmth is necessary, or the heating element 320 may be turned off if the temperature within the thermally-protected battery system 310 becomes warmer than a threshold, not-to-exceed, temperature preset value.

Lead wires 312, 313 comprise negative and positive leads, respectively, leading from the processing unit 315 and pass through the insulating member 330 by way of a preferably sealed grommet 334 to prevent warm air from the heating element 320 from escaping the insulating member 330 of the system 310. The lead wires 312, 313 also pass through the hard outer case 950 by way of a preferably sealed grommet 954 to prevent cold air from getting in our warm air from escaping the thermally-protected battery system 910.

Referring to FIG. 8, an alternate example heating system circuit diagram is shown. The circuit 800 is shown comprising an external microcontroller 860 (e.g., one of the CPU's 460, 460′, 460″, 460′″ of FIGS. 4a, 4b, 4c, 4d, respectively) which monitors at 821 temperature data of the battery 811 from an internal temperature sensor 817 (e.g., internal temperature sensor 317 of FIG. 3). The microcontroller 860 communicates at 822 with an internal processor or heater power selector 815 (e.g., internal processor 315 of FIG. 3). Responsive to signals from the microcontroller 860, the internal processor 815 controls a heating element 820 (e.g., heating element 320 of FIG. 3) within an appropriate temperature range based upon temperature data received from the temperature sensor 817. The microcontroller 860 may also optionally receive and act on external, ambient, temperature data from external temperature sensor 861 which may be part of the electronics device 840 (i.e., device 400, 400′, 400″, 400′″ of FIGS. 4a, 4b, 4c, 4d) of the system to be powered. Also, it will be appreciated that more or less of the electronics of microcontroller 860 may be contained in internal controller 815 depending upon overall system design considerations.

Accordingly, the internal processor 815 may alone, or together with an external microcontroller 860 or CPU, control power to the electronic device to be powered by battery 811 via circuit wires 812 (−) and 813 (+). The microcontroller 860 may also control charging circuitry 802 for charging of the battery 811. Thus, for example, based upon internal temperature data of the battery 811 received from the internal temperature sensor 817, the microcontroller 860 operates a program sending signals to the internal controller 815 for allowing system electronics to operate if the battery temperature is within a maximum and a minimum allowable operating temperature range (e.g., −20° C. and +60° C.). And if the temperature of the battery is below a certain threshold within a thermal insulator 830, for example −10° C., the microcontroller 860 operates a program sending signals to the internal controller 815 activating the heating element 820 to heat the battery 811 via control circuit wire 822 and power circuit wires 824, 825. Microcontroller 860 then turns the heating element 820 off either after a pre-determined time of operation, for example 15 minutes, depending upon the magnitude and amount of heat to be supplied per design, or once a certain temperature is achieved within the thermal insulator 830 per temperature data received by the microcontroller from the temperature sensor 817.

With the basic heating system 800 of FIG. 8, the variables of heating magnitude and heating time are programmed so as to ensure that the battery 811 operates in a generally optimal temperature range. The amount of battery power to be supplied and the time of battery heating operation are designed to work in conjunction with temperature feedback from the internal temperature sensor 817, and optionally an external temperatures sensor 861, to automatically achieve optimum operating temperature of the battery 811. In this way, life of the battery 811 is optimized both for amp-hours maximization and re-cycling maximization of the battery.

Further, the microcontroller 860 monitors the battery temperature and does not allow the battery charging circuitry 802 to charge the battery 811 if the battery temperature is below a minimum charging temperature threshold of 0° C. or above a maximum charging temperature threshold of 45° C. If the user attempts to charge the battery 811 when the temperature is below the minimum charging temperature, the microcontroller 860 enables the battery pack heating element using the external A/C or D/C power feed to raise the temperature above 0° C. Once the battery temperature is above 0° C., the microcontroller then 860 enables the battery charging circuitry 802, and charging begins.

When designing the basic system 800 and program, it should be considered that different battery technologies have different operating temperature limitations. For example, with a Lithium Ion rechargeable battery system, the battery should not be discharged if at a temperature below −20° C. or higher than 60° C. Further, as shown and described previously, such battery systems operate more optimally within certain temperature ranges, for example at around 20° C. Accordingly, the size and volume of the space to be heated, and the efficiency of the insulating member 830 to be selected, together with the resistivity of the heater 820 and quantity of power from the battery 811 to be selected, should be accomplished so as to not risk operation outside of these limits, or so as to not require undue discharge of the battery for heating purposes.

Thus, any of the other aforementioned embodiments or aspects of the invention comprising an internal temperature sensor may be further provided with temperature-controlled battery charging circuitry where the microcontroller monitors battery temperature and does not allow the battery charging circuitry to operate to charge the battery if the battery is below a minimum charging temperature threshold, for example 0° C., or if the battery is above a maximum charging temperature threshold, for example 45° C. This aspect of the invention enables automated charging of the battery even if ambient temperatures are very cold, thus enabling charging of a battery pack which would not otherwise be possible without some other means of heating the battery. This, in turn, represents a convenience to the user not heretofore provided.

Surrounding the insulating member 330, the thermally-protected battery system 310 further preferably comprises an outer protective cover 350, made of metal or plastic and surrounding the insulating member 330. The protective cover 350 is primarily for housing the battery 311, the heating element 320, the control circuitry 315 and the insulating member 330, thus preventing them from damage or disassembly. Further, the contact leads 312, 313 also pass through a portion of the protective cover 350, as through a sealing grommet 354, to enable interconnection of the battery 311 within the protective cover, and within the insulation member/barrier 330, to the electronic device for which the battery is intended for power.

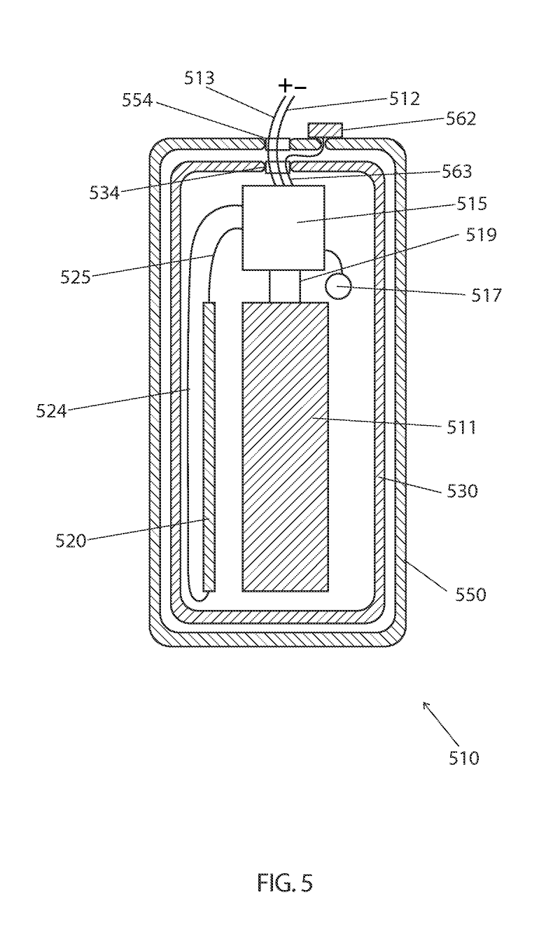

Referring now to FIG. 5, there is shown an alternate embodiment of a thermally-protected heatable chemical cell battery system 510 in accordance with another aspect of the invention. The thermally-protected chemical cell battery system 510 of this embodiment of the invention, similarly to the thermally-protected chemical battery systems 210 and 310, comprises a chemical cell battery 511, such as a lithium-ion, a lithium-poly or other chemical cell battery that is susceptible to reduced performance during operation in excess temperature environments, a heating element 520, and similar to thermally-protected chemical cell battery system 310, an internal processing unit 515 preferably contained on a circuit board 515. The chemical cell battery 511 is operatively interconnected to the internal processor 515, and the processor also is operatively interconnected to the heating element 520. The interconnection between the battery 511 and the processor 515 is comprised of lead wires 519. Further, there are lead wires 524, 525 which operatively interconnect the heating element 520 and the processor 515. The processor 515 controls the amount of power from the battery 511 supplied to the heating element 520 similarly to that described in connection with either FIG. 7 or FIG. 8, depending upon whether temperature feedback circuitry 517 (shown in dotted lines as optional) is included.

Similarly to the thermally-protected chemical cell battery systems 210, 310 described in connection with FIGS. 2 and 3, respectively, the thermally-protected chemical cell battery system 510 of FIG. 5 further comprises an insulating member 530 comprised preferably of Aerogel or other suitable insulating material. Preferably, the insulating member 530 surrounds, or otherwise contains, the battery 511, the heating element 530, the processor 515 and lead wires 519, 524 and 525.

The thermally-protected chemical cell battery system 510 differs from the thermally-protected chemical cell battery system 310 in that the system 510 does not necessarily include fully automated adjustment of power to the heating element 520 based upon feedback from a temperature sensor since this embodiment further comprises a manual on/off switch 562 and related wiring 563 operatively connecting the switch and the processor 515. Rather, a temperature sensor 517 for the present embodiment is shown with dotted lines in FIG. 5 signifying that the temperature sensor is optionally limited to enable determination of the battery operating temperature, as affected by the heating element 520 and the ambient temperature within the insulating member 530, to enable feedback to the processor 515 and automatic electronic shut-off of battery power to the heating element 520 to prevent overheating of the battery beyond a safe operating temperature.

Lead wires 512, 513 comprise negative and positive leads, respectively, leading from the processor 515 which pass through the insulating member 530 by way of a preferably sealed grommet 534 to prevent warm air from the heating element 520 from escaping the insulating member 530 of the thermally-protected heated chemical cell battery system 510.

Surrounding the insulating member 530, the thermally-protected chemical cell battery system 510 further preferably comprises an outer protective cover 550 made of metal or plastic and surrounding the insulating member 530. The protective cover 550 is primarily for housing the battery 511, the heating element 520, the control circuitry 515 and the insulating member 530, thus preventing them from damage or disassembly. Further, the contact leads 512, 513 also pass through a portion of the protective cover 550, as through a sealing grommet 554, to enable interconnection of the battery 511 within the protective cover, and within the insulation member/barrier 530, to the electronic device for which the battery is intended for power.

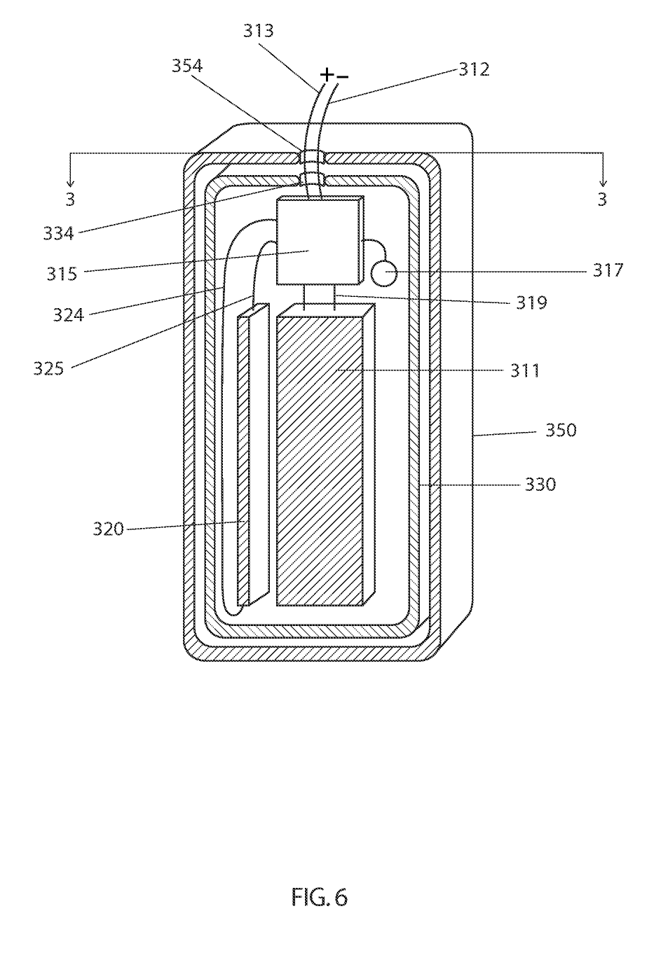

Referring now to FIG. 6, there is provided an alternate view of the thermally-protected heatable chemical cell battery system 310 and showing by way of example the location for the section used for clarification through the various embodiments of the invention described herein.

Referring now more specifically to FIGS. 4a-4d, there are shown different implementations of an aspect of the present invention allowing for example the use of a thermally-protected chemical cell battery system 410, 410′, 410″, 410′″ to power a cell phone 400 (FIG. 4a), a hand-held GPS device 400′ (FIG. 4b), a portable computing device 400″ (FIG. 4c), such as a tablet touchscreen computer, or a pair of heated goggles 400′″ (FIG. 4d), respectively. This aspect of the invention provides better battery performance for such electronic devices in cold weather extremes.

In FIG. 4a, a hand-held cellular telephone is shown, such as a smart phone 400 with a back cover removed to show the battery system 410 in cross section. The battery system 410 is similar to the battery system 310 shown in FIG. 3. Thus, the battery system 410 comprises a battery 411, a processor 415, a heating element 420, an insulating member 430, a temperature sensor 417, and lead wires 412, 413, 419, 424, 425 wherein the lead wires 412, 413 pass through sealed grommets 434, 454. All of the foregoing elements are virtually the same and provide similar functions to that described in connection with battery system 310 of FIG. 3. The smart phone 400 also comprises a camera lens 461 and a CPU 460. The CPU 460 is operatively interconnected with the processor 415 of the thermally-protected chemical cell battery system 410 so as to enable provision of power and passing of any necessary control signals between the smart phone and the battery system. Thus, for example, in this embodiment of this aspect of the invention, control of the heating element and temperature feedback functions may be operated with the processor 415, whereas control of the cell phone system may be operated with CPU 460. It will be appreciated that division of processing between the two processors 415, 460 will be allocated in accordance with generally accepted principals of computing generally understood in the art. It will be further appreciated that the function of the protective cover of other embodiments of the invention would be provided by a case 462 of the smart phone 400.

In FIG. 4b, a hand-held GPS device 410′ is shown with a back cover removed to show the battery system 410′ in cross section. The battery system 410′ is similar to the battery system 210 shown in FIG. 2, except the battery system 410′ further comprises a temperature sensor 417′. Thus, the battery system 410′ comprises a battery 411′, a heating element 420′, an insulating member 430′, the temperature sensor 417′, and lead wires 412′, 413′, 424′, 425′ wherein the lead wires 412′, 413′ pass through sealed grommets 434′, 454′. All of the foregoing elements are virtually the same and provide similar functions to that described in connection with battery system 210 of FIG. 2. The GPS 410′ also comprises an antenna 463 and a CPU 460′. The CPU 460′ is operatively interconnected with battery 411′ of the thermally-protected chemical cell battery system 410′ so as to enable provision of power and passing of necessary control signals between the GPS 400′ and the battery system. Thus, for example, in this embodiment of this aspect of the invention, control of the heating element and temperature feedback functions may be operated with the CPU 460′, and furthermore, control of the GPS 400′ may also be operated with the same CPU 460. It will be appreciated that the function of the protective cover of other embodiments of the invention would be provided by a case 462′ of the GPS 400′.

In FIG. 4c, a tablet computing device 400″ is shown with a back cover removed to show the battery system 410″ in cross section. The battery system 410″ is similar to the battery system 310 shown in FIG. 3. Thus, the battery system 410″ comprises a chemical cell battery 411″, a processor 415″, a heating element 420″, an insulating member 430″, a temperature sensor 417″, and lead wires 412″, 413″, 419″, 424″, 425″ wherein the lead wires 412″, 413″ pass through sealed grommets 434″, 454″. All of the foregoing elements are virtually the same and provide similar functions to that described in connection with battery system 310 of FIG. 3. The tablet computing device 400″ also comprises a camera lens 461′ and a CPU 460″. The CPU 460″ is operatively interconnected with the processor 415″ of the thermally-protected chemical cell battery system 410″ so as to enable provision of power and passing of any necessary control signals between the tablet computing device 400″ and the battery system 410″. Thus, for example, in this embodiment of this aspect of the invention, control of the heating element and temperature feedback functions may be operated with the processor 415″, whereas control of the tablet device 400″ may be operated with CPU 460″. It will be appreciated that division of processing between the two processors 415″, 460″ will be allocated in accordance with generally accepted principals of computing generally understood in the art. It will be further appreciated that the function of the protective cover of other embodiments of the invention would be provided by a case 462″ of the tablet computing device 400″.

In FIG. 4d, a thermally-protected heatable goggle system 400′″ is shown with a front cover removed to show the battery system 410′″ in cross section. The battery system 410′″ is similar to the battery system 310 shown in FIG. 3, except a processor 415′″ of battery system 410′″ not only may provide control for heating of a battery 411′″, but also provide control for heating of the goggle 400′″ and related electronics. Thus, the battery system 410′″ comprises a battery 411′″, a processor 415′″, a heating element 420′″, an insulating member 430′″, a temperature sensor 417′″, and lead wires 412′″, 413′″, 419′″, 424′″, 425′″ wherein the lead wires 412′″, 413′″ pass through sealed grommets 434′″, 454′″. All of the foregoing elements are virtually the same and provide similar functions to that described in connection with battery system 310 of FIG. 3. The heated goggle 400′″ may also comprise optionally a CPU 460′″ (shown in dotted lines) and related control circuitry 463′″ operatively interconnecting the CPU 460′″ and the processor 415′″. The optional CPU 460′″ is operatively interconnected with the processor 415′″ of the thermally-protected heated chemical cell battery system 410′″ so as to enable provision of power and passing of any necessary control signals between the goggle 400′″ and the battery system. Thus, for example, in this embodiment of this aspect of the invention, control of the heating element and temperature feedback functions may be operated with the processor 415′″, whereas control of the goggle system 400′″ may be operated with CPU 460′″. It will be appreciated that division of processing between the two processors 415′″, 460′″ will be allocated in accordance with generally accepted principals of computing generally understood in the art. It will be further appreciated that the function of the protective cover of other embodiments of the invention would be provided by a case 462′″ of the goggle 400′″.

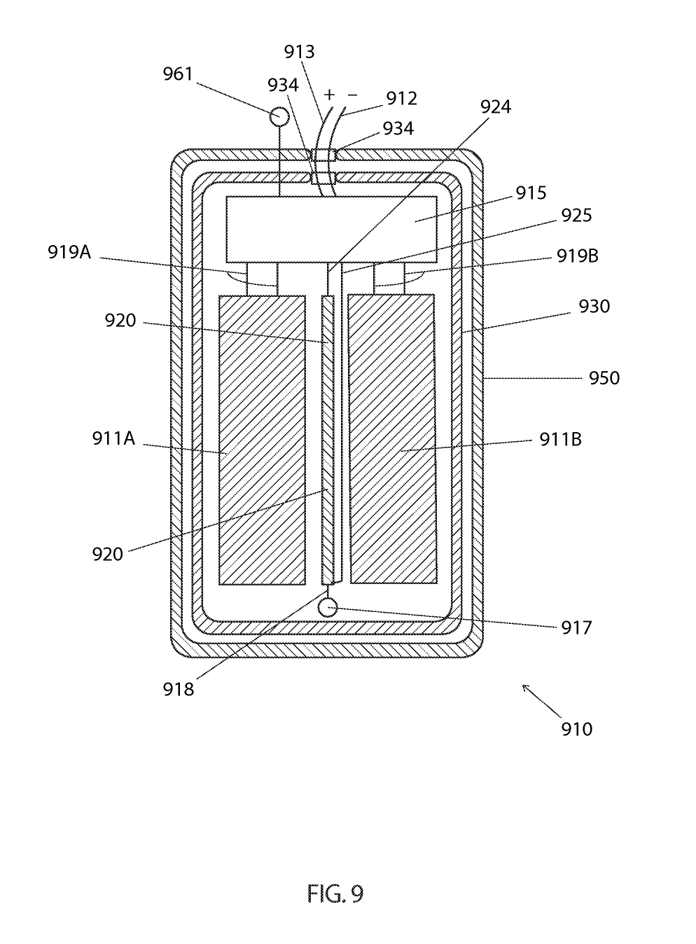

Referring to FIG. 9, there is shown an alternate embodiment of a thermally-protected heatable chemical cell battery system 910. Similar to thermally-protected chemical cell battery system 310, battery system 910 comprises a chemical cell battery 911A, such as a rechargeable lithium-ion, lithium-poly, or other chemical cell battery, that is susceptible to reduced performance during operation in excess temperature environments, and a heating element 920. Battery system 910 further comprises a second chemical cell battery 911B. Both batteries 911A and 911B are operatively connected with control circuitry on a circuit board 915.

Thus, in accordance with this aspect of the invention, and as shown by way of example with thermally-protected heated battery system 910, any of the embodiments of the invention described previously may include one or more additional batteries as part of the thermally-protected battery system without departing from the true scope and spirit of the invention as claimed. In accordance with this alternate embodiment thermally-protected heated chemical cell battery system 910, the insulating member 930, for example an Aerogel insulating member, at least partially surrounds, but preferably would substantially completely surround, the first battery 911A, the second battery 911B, the control circuitry 915 and the heating element 920. Further, in the case where a metal or hard plastic protective cover 950 is employed, the protective cover would further at least partially surround, but preferably would substantially completely surround, the first battery 911A, the second battery 911B, the control circuitry 915, the heating element 920 and the insulating member 930.

Preferably, the heating element 920 of thermally-protected chemical battery system 910 is positioned between the first chemical cell battery 911A and the second chemical cell battery 911B to enable efficient heating of both batteries with a single heating element.

The interconnection between the batteries 911A, 911B and the processor 915 is comprised of lead wires 919A and 919B, respectively. Further, the system 910 further comprises lead wires 924, 925 which operatively interconnect the heating element 920 and the processing unit 915. The system 910 further comprises negative and positive lead wires 912, 913, respectively, leading from the processing unit 915 and pass through the insulating member 930 by way of a preferably sealed grommet 934 to prevent warm air from the heating element 920 from escaping the insulating member 930 of the system 910. Lead wires 912, 913 provide power to the device to be powered by the thermally-protected battery system 910.

Similar to battery system 310 shown in FIG. 3, the thermally-protected battery system 910 of FIG. 9 may also comprise an internal temperature sensor 917 with temperature feedback circuitry 918 for enabling operation in accordance with control circuitry 800 similar to that shown and described above in connection with FIG. 8. Without the internal temperature sensor 917 and temperature feedback circuitry 918, though optionally with an external temperature sensor 961, the operation of battery system 910 would be more like that shown and described above in connection with control circuitry 700 of FIG. 7.

The thermally-protected heated battery system 910 enables the user to have more battery power in a single thermally-protected heated chemical cell battery system by providing for a plurality of batteries 911A and 911B within a single battery pack encased by a hard case 950. This in turn allows longer battery activation times for the device (e.g., 400, 400′, 400″, 400′″) to be powered by the battery system 910. It will be appreciated by those skilled in the art that additional batteries may be employed with in this aspect of the invention without departing from the true scope and spirit of the invention as claimed.

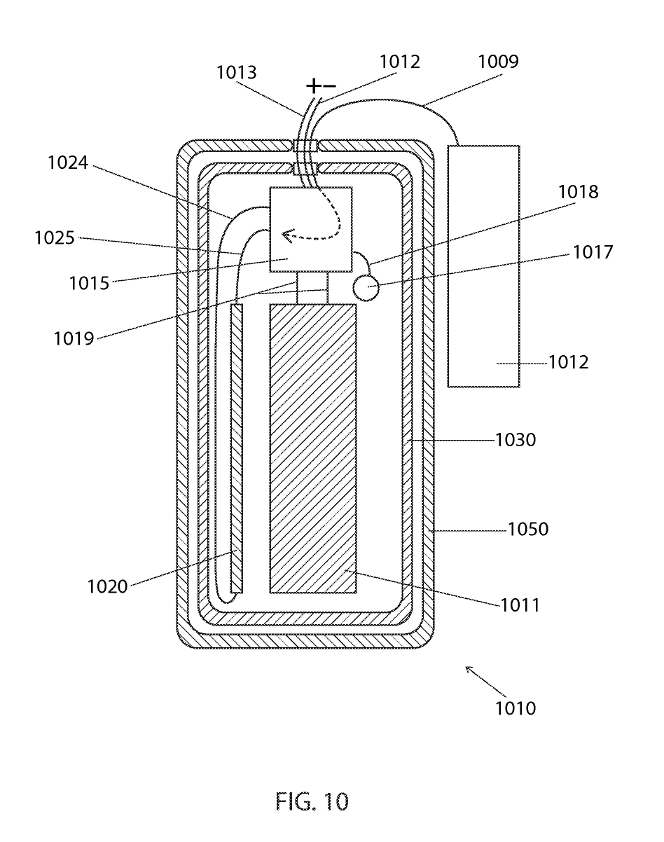

Referring to FIG. 10, there is shown an alternate embodiment of a thermally-protected heatable chemical cell battery system 1010 in accordance with an aspect of the invention. The battery system 1010, similarly to the thermally-protected chemical cell battery system 310, comprises a first chemical cell battery 1011, such as a rechargeable lithium-ion, lithium-poly, or other chemical cell battery, that is susceptible to reduced performance during operation in excess temperature environments, a heating element 1020 and an insulating member 1030 surrounding the battery and the heating element. In this embodiment of the invention, there is an internal processor 1015, though it will be appreciated that an external processor, similar to processor 260 of FIG. 2, may be used. This embodiment further comprises another battery (i.e., a backup battery) 1012 that is designed for operation in colder weather and is operatively connected via circuit wire 1009 with the heating element 1020. The other battery 1012 in accordance with this embodiment of the invention comprises a lithium iron phosphate (LiFePo₄) battery, or a lithium/iron disulfide battery (Li/FeS₂—e.g., an Energizer® L91 battery), or other battery or power source able to function down to −40° C. This other battery 1012 may be located and retained outside of the insulating member 1030, since it is able to operate at colder temperatures, and may be used to power the heater 1020 to warm the first battery 1011 housed within the insulating member. In this embodiment of the invention, the insulating member 1030, for example an Aerogel insulating member, at least partially surrounds the first battery (i.e., the battery first mentioned above) 1011, and the heating element 1020. Further, in accordance with an aspect of the invention, there is provided protective cover 1050. The protective cover 1050 may be made of metal, hard plastic, or other sufficiently rigid material so as to provide protection to the battery 1011 and the insulating member 1030 housed within. The backup battery 1012 need not be retained within the insulating member 1030 or the protective cover 1050.

Similar to previously-described embodiments, battery system 1010 also comprises lead wires 1024, 1025, 1013, 1012, an internal temperature sensor 1017 and temperature feedback circuitry 318. Lead wires 1012, 1013 and 1009 pass through sealed grommets 1034, 1054 similarly to that described in connection with battery system 310 shown in FIG. 3. Also, similarly to battery system 310, the interconnection between the battery 1011 and the processor 1015 is comprised of lead wires 1019.

In operation, if the temperature of the first, or primary, battery 1011 falls below its recommended operating temperature, the other, backup, battery 1012 is used to warm the first battery up to a minimum threshold temperature before attempting use or charging of the first battery. The other, backup, battery 1012 may be activated with the use of an on/off switch (not shown), or it may be controlled with temperature sensor 1017 and control circuitry 1018, 1015. Once the first battery 1011 achieve sufficient warmth for operation on its own, power for maintaining the first battery within an appropriate operating temperature may be supplied either from the first battery or the backup battery 1012.

This aspect of the invention enables the user to have more flexibility in how the primary battery 1011 may be warmed to enable efficient operation and charging, since the external battery 1012, e.g., an Energizer® L91 battery, may be housed outside of the primary battery pack 1010 and not surrounded by the insulating member 1030 and optionally the protective cover 1050. This, in turn allows for differing, and flexible, packaging approaches to the battery pack in accordance with this embodiment of the invention.

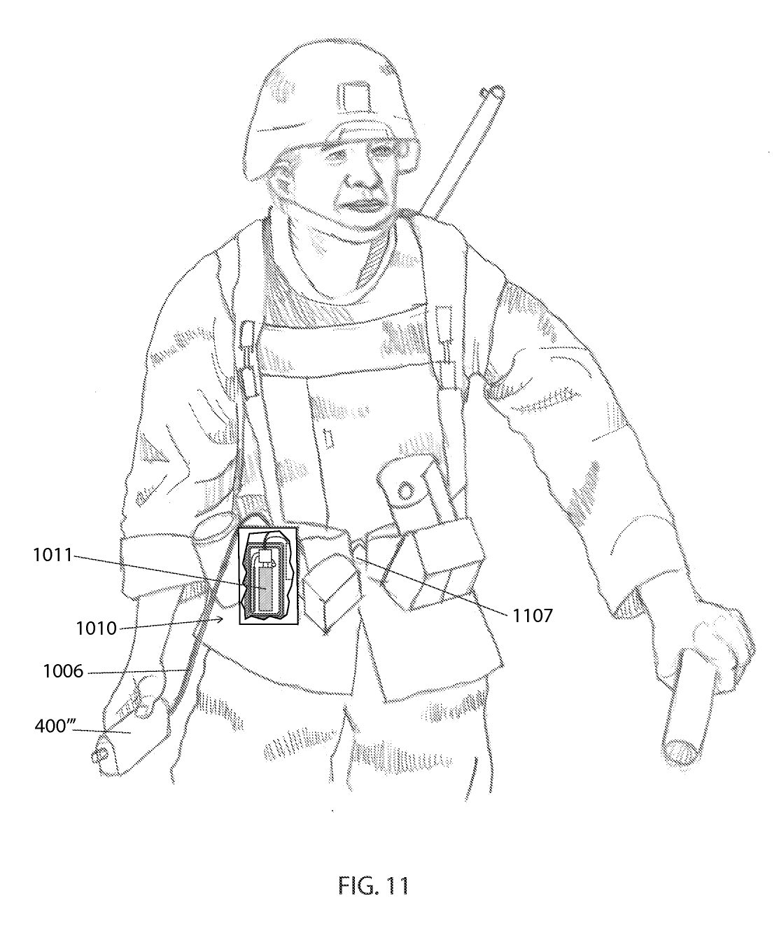

Referring to FIG. 11, an exemplary mode of use is illustrated with a military person using a thermally-protected heatable chemical cell battery system 1010, like that shown and described in connection with FIG. 10, with the battery system being worn on a tool belt 1107, to provide a back-up, external power supply 1011 via the thermally-protected heated battery system 1010 wired via wiring 1006 to allow back-up power to operate a hand-held GPS system 400″. Thus, while the GPS system 410′, like that shown in FIG. 4B, may have an internal thermally-protected battery system 410′, it will thus be appreciated that further back-up power may be provided to the GPS system by the external power supply system 1010. Of course, it will be appreciated that any of the other embodiments of the present invention shown and described may be used by such military personnel, and any embodiment of the invention may be similarly used by outdoor recreationists, athletes, rescue personnel or other first responders, to enhance battery life for operating hand-held electronic devices, or laptop computers, in cold weather environments.

While a preferred embodiment of the present invention has been shown and described, it will be apparent to those skilled in the art that many changes and modifications may be made without departing from the invention in its broader aspects. For example, it will be appreciated that one of ordinary skill in the art may mix and match the various components of the various embodiments of the invention without departing from the true spirit of the invention as claimed. Thus, by way of example, it will be appreciated that a temperature sensor embodiment may be used with a GPS hand-held device, or a non-temperature sensor version may be used with a hand-held computing device, without departing from the scope of the invention. Further, interchanging functionality among different available processors likewise would not depart from the spirit and scope of the invention. The appended claims are therefore intended to cover all such changes and modifications as fall within the true spirit and scope of the invention.

What is claimed is:

1. A thermally-protected chemical cell battery system adapted for providing power to an electronic device comprising:
a. a chemical cell battery;
b. a heating element operatively connected with said battery, said heating element being powered by said battery and located adjacent said battery;
c. an insulating member at least partially surrounding said battery and said heating element; and
d. contact leads passing through said insulating member adapted for conveying power from the battery to the electronic device.

2. The thermally-protected chemical cell battery of claim 1, wherein said insulating member comprises an Aerogel enclosure, and wherein said heating element and said battery are fully contained within said insulating member for enabling sufficient warmth to the battery using a minimum of battery power.

3. The thermally-protected chemical cell battery of claim 2, further comprising a hand-held electronic device to be powered by said battery, and wherein the thermally-protected chemical cell battery is carried within said electronic device.

4. The thermally-protected chemical cell battery of claim 3, wherein said electronic device comprises control circuitry for diverting power from said battery to said heating element.

5. The thermally-protected chemical cell battery system of claim 4, further comprising a second chemical cell battery operatively connected with said control circuitry, wherein said Aerogel insulating member at least partially surrounds said battery, said second battery, said control circuitry and said heating element, and wherein said heating element is positioned between said chemical cell battery and said second chemical cell battery to enable heating of both batteries with a single heating element.

6. A thermally-protected chemical cell battery system adapted for providing power to an electronic device comprising:
a. a chemical cell battery;
b. control circuitry operatively connected with said battery;
c. a heating element operatively connected with said control circuitry and said battery, said heating element being powered by said battery and located adjacent said battery, said control circuitry providing sufficient power from said battery to said heating element to improve the operating performance of said battery;
d. an Aerogel insulating member surrounding said battery and said heating element;
e. contact leads passing through a portion of said insulating member adapted for conveying power from said battery to the electronic device.

7. The thermally-protected chemical cell battery of claim 6, wherein said heating element and said battery are fully contained within said insulating member for enabling warmth to the battery using less battery power over a single use cycle than would otherwise be lost as a result of operating the battery at cold temperatures.

8. The thermally-protected chemical cell battery of claim 7, further comprising an electronic device to be powered by said battery, and wherein the thermally-protected chemical cell battery is carried within said electronic device.

9. The thermally-protected chemical cell battery of claim 7, further comprising an external cold weather battery adapted for heating said battery housed within said insulating member.

10. The thermally-protected chemical cell battery of claim 8, wherein said control circuitry is part of said electronic device for diverting a minimum of power from said battery to said heating element.

11. The thermally-protected chemical cell battery of claim 6, further comprising a protective cover surrounding the insulating member, and wherein said contact leads also pass through a portion of said protective cover.

12. The thermally-protected chemical cell battery of claim 6, further comprising a switch for switching on or off the heating element for heating the battery.

13. The thermally-protected chemical cell battery of claim 6, further comprising a temperature sensor and temperature feedback circuitry to said control circuitry, and wherein said control circuitry automatically adjusts power to said heating element upon receipt of a temperature input from said temperature sensor.

14. The thermally-protected chemical cell battery of claim 13, further comprising a controlled charging system enabling charging of said battery upon verification that the temperature of the battery is within a pre-determined range, said charging system automatically signaling heating of said battery by said heater in the event said battery is verified to be at a temperature below the pre-determined temperature range, whereupon increasing the temperature of said battery to within the pre-determined range automatically signals commencement of charging of said battery by said charging system.

15. The thermally-protected chemical cell battery of claim 6, wherein said chemical cell battery further comprises a Lithium-Ion battery.

16. The thermally-protected chemical cell battery of claim 6, wherein said chemical cell battery further comprises a Lithium-Poly battery.

17. The thermally-protected chemical cell battery of claim of claim 7, further comprising a second chemical cell battery operatively connected with said control circuitry, wherein said insulating member at least partially surrounds said battery, said second battery, said control circuitry and said heating element, and wherein said heating element is positioned between said chemical cell battery and said second chemical cell battery to enable heating of both batteries with a single heating element.

18. A thermally-protected heated chemical cell battery system adapted for providing power to an electronic device comprising:
a. a chemical cell battery;
b. control circuitry operatively connected with said battery;
c. a heating element operatively connected with said control circuitry and said battery, said heating element being powered by said battery and located adjacent said battery, said control circuitry providing sufficient power from said battery to said heating element to improve the operating performance of said battery;
d. an Aerogel insulating member at least partially surrounding said battery, said control circuitry and said heating element;
e. a metal protective cover at least partially surrounding said battery, said control circuitry, said heating element and said Aerogel insulating member;
f. contact leads passing through a portion of said insulating member and a portion of said protective cover adapted for conveying power from the battery to the electronic device.

19. The thermally-protected heated chemical cell battery of claim 18, further comprising a temperature sensor and temperature feedback circuitry to said control circuitry, and wherein said control circuitry automatically adjusts power to said heating element upon receipt of a temperature input from said temperature sensor.

20. The thermally-protected heated chemical cell battery of claim 19, further comprising a controlled charging system enabling charging of said battery upon verification that the temperature of the battery is within a pre-determined range, said charging system automatically signaling heating of said battery by said heater in the event said battery is verified to be at a temperature below the pre-determined temperature range, whereupon increasing the temperature of said battery to within the pre-determined range automatically signals commencement of charging of said battery by said charging system.

21. The thermally-protected heated chemical cell battery system of claim 18, further comprising a second chemical cell battery operatively connected with said control circuitry, wherein said Aerogel insulating member at least partially surrounds said battery, said second battery, said control circuitry and said heating element, wherein said metal protective cover at least partially surrounds said battery, said second battery, said control circuitry, said heating element and said Aerogel insulating member, and wherein said heating element is positioned between said chemical cell battery and said second chemical cell battery to enable heating of both batteries with a single heating element.
